(19) United States
(12) Patent Application Publication
(10) Pub. No.: US 2010/0180715 A1
(43) Pub. Date: Jul. 22, 2010

(54) LEVER WITH HOUSING FOR SERVICE TOOL SUITABLE FOR MOUNTING AND DISMANTLING ACCESSORIES

(76) Inventor: Guido Valentini, Milano (IT)

Correspondence Address: J. Rodman Steele;Novak Druce & Quigg LLP, 525 Okeechobee Blvd, Suite 1500, West Palm Beach, FL, 33401, US

(21) Appl. No.: 12/689,758

(22) Filed: Jan. 19, 2010

(30) Foreign Application Priority Data
Jan. 20, 2009 (IT) MI2009U000014

(51) Int. Cl. G05G 1/04

(52) U.S. Cl. 74/523

(57) ABSTRACT

A control lever for a machine for machining surfaces is disclosed that comprises at least one housing for at least one tool, in particular for an L-shaped Allen key (6). Said lever comprises a housing (5) for the long shaft (7) and a housing (8) for the short shaft (9) of the Allen key (6).

The present invention relates to a lever with housing for a service tool that is suitable for mounting and dismantling accessories for machining surfaces.

Machines for machining surfaces are known, for example sanding machines, lapping machines and polishing machines, comprising a control lever hinged on the frame of the machine near the grip.

After a series of work sessions it is necessary to replace the consumable element or member that is subject to machine wear, for example the pad that is usually connected by an Allen screw to mechanical means for the rotational-orbital motion of the pad.

For the user there is therefore the need to always have a tool with himself that is useful for said replacement, for example an Allen key, a screwdriver or a spanner.

The Allen keys that are useful for this purpose are usually L-shaped to facilitate user movements.

The user is often devoid of such movement tools and has to interrupt machining for not insignificant periods of time, which are certainly much longer than the time taken to replace the pad or other members that are subject to wear.

As said Allen keys are often of reduced dimensions, it is easy to lose the keys or to confuse similar measurements (a few millimetres of difference) that are not suitable for replacing the consumable element of the machine.

The object of this invention is to supplement a machine for machining surfaces in a removable manner with a movement tool for mounting and dismantling the consumable element of a machine for machining surfaces, which machine is usually very compact.

According to the invention, this object is achieved with a control lever for a machine for machining surfaces, characterised in that it provides at least one housing for at least one tool suitable for mounting and dismantling members that are subject to machine wear.

Advantageously, the lever provides a housing for the long shaft of an L-shaped Allen key and a front housing in the shape of a hook for the short shaft of said Allen key that is suitable for preventing the Allen key from leaving the lever housing.

These and other features of this invention will be made clearer by the following detailed description of a practical embodiment thereof illustrated by way of non-limiting example in the attached drawings in which:

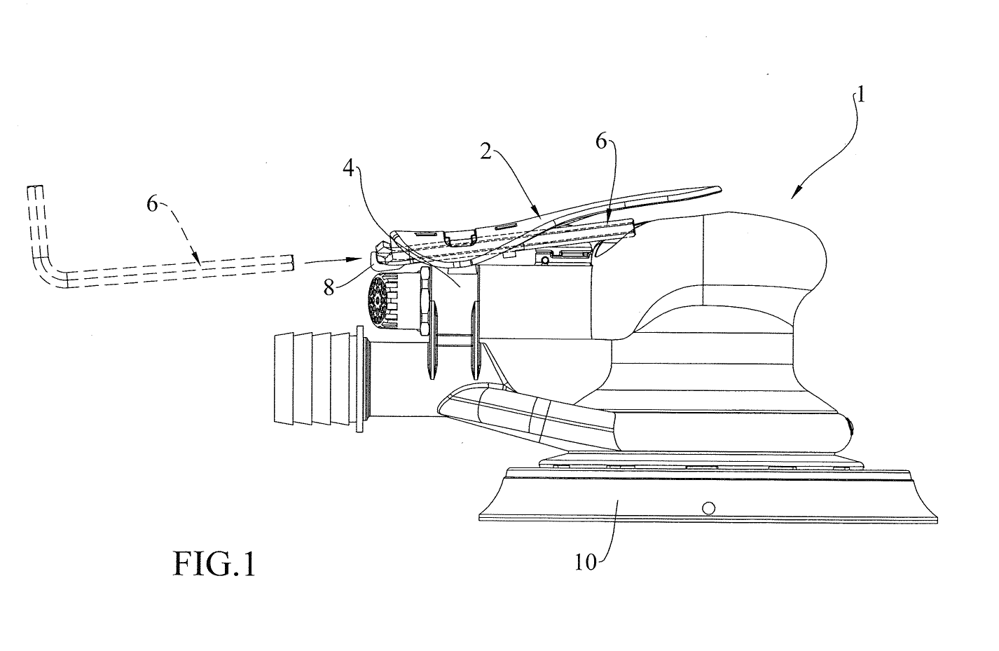

FIG. 1 shows a side view of a sanding machine with a lever according to the present invention;

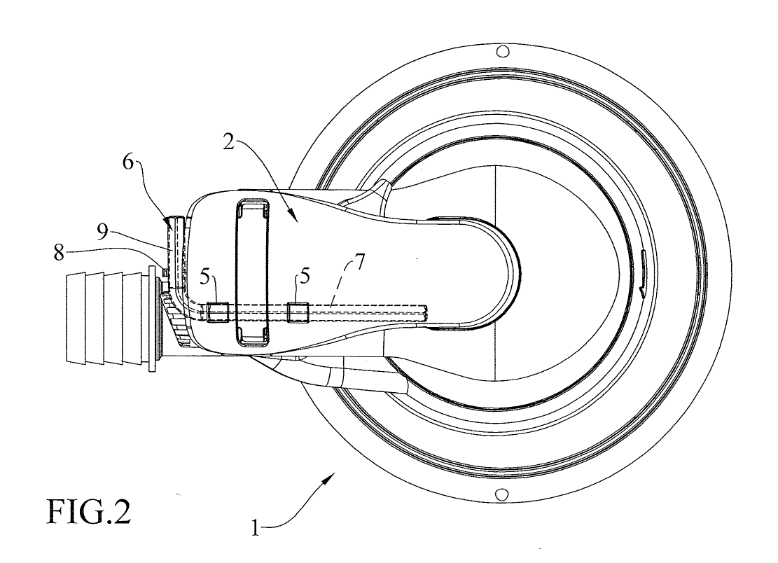

FIG. 2 shows a top plan view of the machine in FIG. 1;

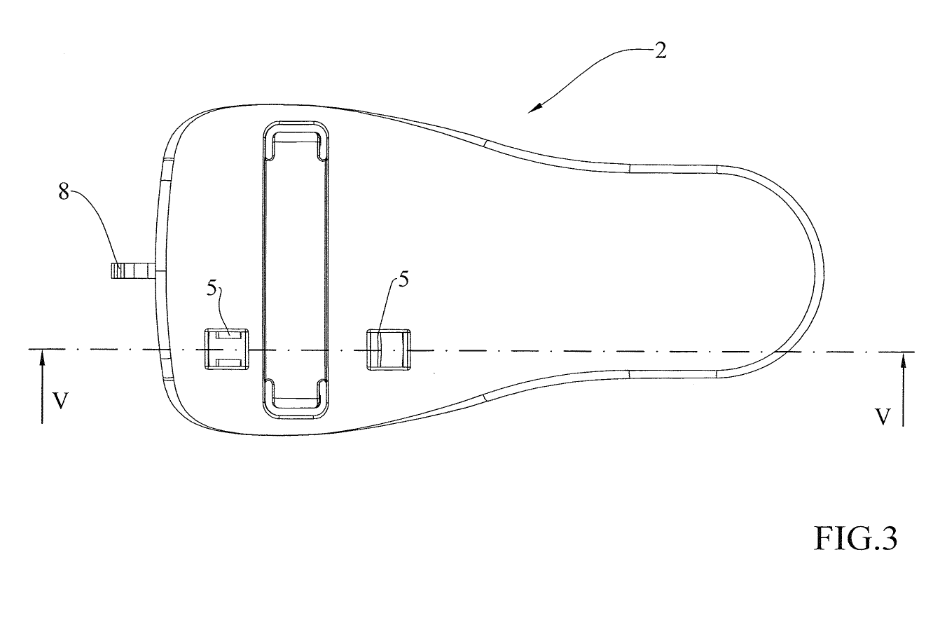

FIG. 3 shows a top plan view of a lever according to the present invention;

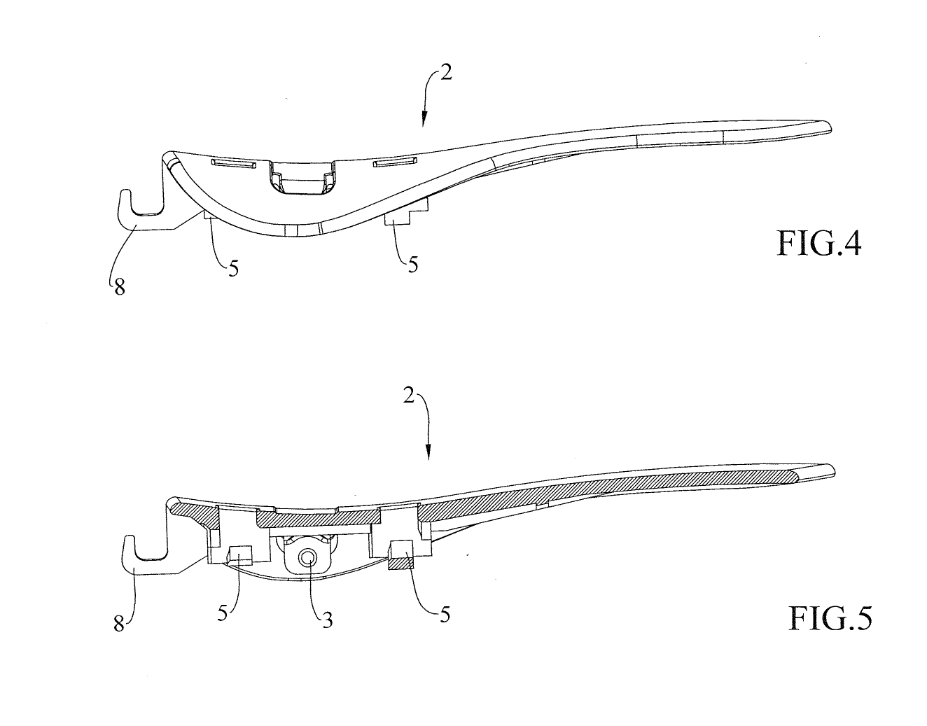

FIG. 4 shows a side view of the lever in FIG. 3;

FIG. 5 shows a section view according to the line V-V in FIG. 3;

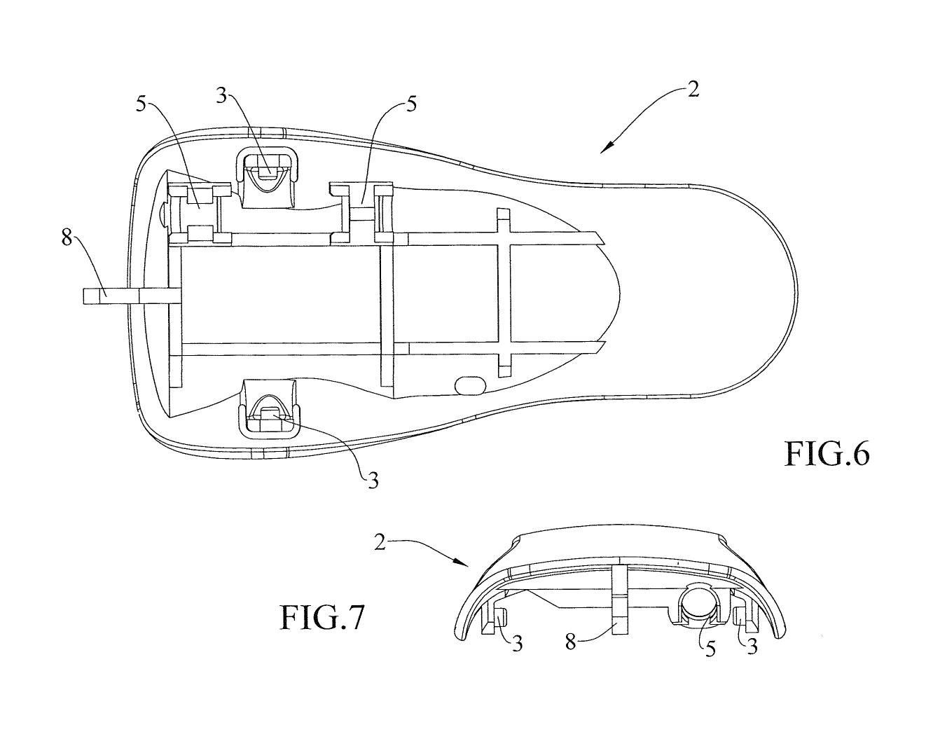

FIG. 6 shows a bottom plan view of the lever in FIG. 3;

FIG. 7 shows a front view of the lever in FIG. 3;

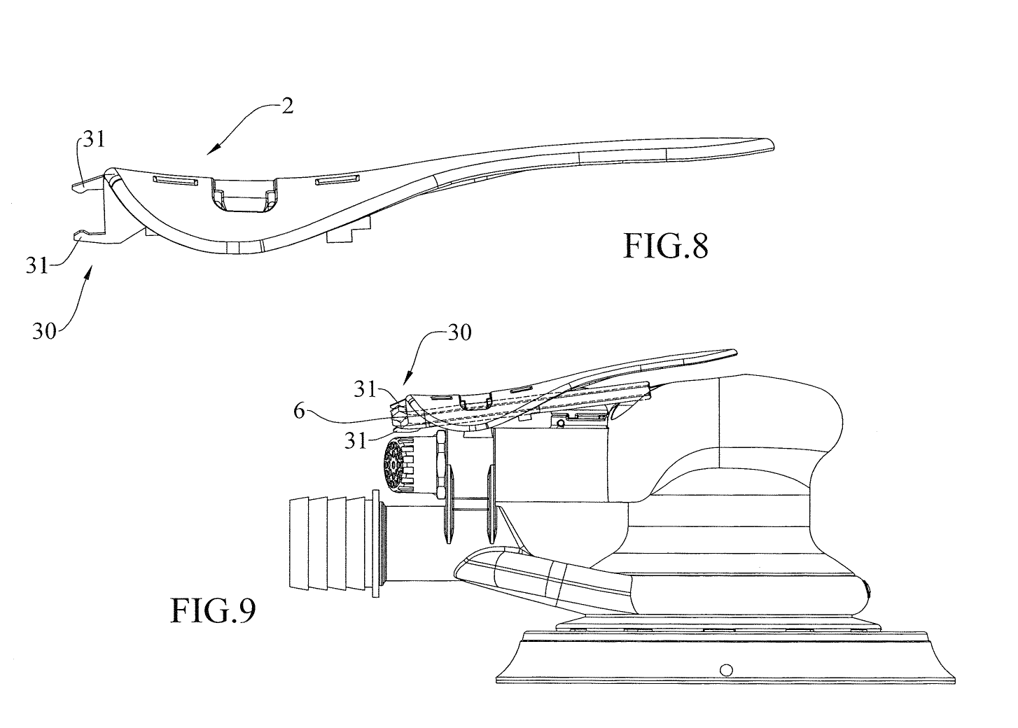

FIG. 8 shows a side view of a second embodiment of the front housing;

FIG. 9 shows a side view of a sanding machine with front housing according to FIG. 8.

A sanding machine 1 (FIGS. 1 and 2) comprises a control lever 2 that is rotatably connected by pivots 3 to the frame 4 of said machine 1.

The lever 2 provides below a pair of supports or consecutive cylindrical housings 5 into which an L-shaped Allen key 6 is insertable, in particular the longer shaft 7 of the “L”.

The lever 2 further comprises frontally a further housing 8 (FIGS. 4, 5) on which the short shaft 9 of the Allen key 6 is supportable, the long shaft 7 being rotatable inside the supports 5.

The housing 8 is hook-shaped (or rather crook-shaped) and enables the Allen key 6 to be locked without the risk of the Allen key 6 accidentally leaving the cylindrical housings 5: it is necessary for the Allen key 6 to be rotated to be disengaged.

In FIGS. 8-9 there is shown a front housing 30 that has a pair of lips 31 for restraining the short shaft 9 of the Allen key without the need for any rotation of the Allen key envisaged in the case of supporting housing 8.

Advantageously the user can work by operating the lever 2 without any impediment caused by the Allen key 6, which is well connected to the lower part of the lever 2 without any disturbance to the rotation of the lever.

The housings 5, 8 can interfere slightly with the Allen key 6 to limit the vibrations during work, without however compromising the possibility of rotating the long shaft 7 inside the housings 5.

The housings 5, 8 are designed with measurements that are such as not to compromise the operation of the lever. In addition, the Allen key 6 has reduced dimensions and does not appreciably increase the total weight of the machine.

The Allen key 6 can be removed by the user to replace the worn pad 10.

Further embodiments of the lever 2 can provide housings for tools other than the Allen key, for example a spanner or a screwdriver. In this case the front housing 8 or 30 is unnecessary, whilst a specific restraining lock is suitable for the lower housings 5 for said tools (the shaft of the screwdriver is much narrower than that of the spanner, which does not have a circular section).

It is fundamental that the housing integrated in the lever 2 enables the tool to be locked securely (without vibrations) and does not compromise the functionality of the lever by limiting, for example, the rotation angle thereof.

If the space permits it, it is possible to provide housings for various service tools under the same lever, for example an Allen key and a screwdriver; for the embodiment in FIG. 6, it is sufficient to add a pair of consecutive cylindrical housings 5 below, the length of the screwdriver must not compromise the fixing of the short shaft 9 of the Allen key 6 to the front housing 8, 30.

1. Control lever for machine for machining surfaces, wherein said control lever provides at least one housing (5, 8, 30) for at least one tool (6) suitable for mounting and dismantling members of the machine that are subject to wear.

2. Lever according to claim 1, wherein said control lever provides below at least a pair of consecutive cylindrical housings (5) into which the long shaft (7) of an L-shaped Allen key (6) is insertable, the short shaft (9) being engageable with a further front housing (8, 30).

3. Lever according to claim 2, wherein said front housing (8) is hook-shaped, the long shaft (7) being rotatable inside the consecutive cylindrical housings (5).

4. Lever according to claim 2, wherein said front housing (30) comprises a pair of lips (31) within which the short shaft (9) is restrainable.

5. Lever according to claim 1, wherein said control lever provides at least one pair of consecutive housings (5).
